(19) United States
(12) Patent Application Publication
(10) Pub. No.: US 2006/0187304 A1
(43) Pub. Date: Aug. 24, 2006

(54) Device for monitoring the vicinities of a vehicle

(75) Inventor: Ryuji Sakata, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/355,068

(22) Filed: Feb. 16, 2006

(30) Foreign Application Priority Data
Feb. 18, 2005 (JP) JP-2005-42813

(51) Int. Cl. H04N 7/18; G08G 1/00

(52) U.S. Cl. 348/148; 340/901

(57) ABSTRACT

A device for monitoring the vicinity of a vehicle includes a display unit, cameras installed on the doors of the vehicle to take images of the conditions in the vicinities of the vehicle and a display control processing device which instructs the cameras to take images of the conditions in the vicinities of the vehicle and displays, on the display unit, the images of the vicinities of the vehicle taken by the cameras. The device for monitoring the vicinities of the vehicle further includes a door opening/closing detector for detecting the opening/closing state of the doors of the vehicle and a halting device for halting the processing of the display control processing device when it is detected by the door opening/closing detector that the doors of the vehicle are opened.

### CROSS REFERENCE TO RELATED APPLICATION

This application is based on and incorporates herein by reference Japanese patent application No. 2005-42813 filed on Feb. 18, 2005.

### TECHNICAL FIELD

The technical field relates to a device for monitoring the vicinity of a vehicle.

### BACKGROUND

A device for monitoring the vicinity of a vehicle has heretofore been proposed for displaying, on a display unit, images of the conditions in the vicinities of the vehicle. According to this device for monitoring the vicinities of the vehicle, for example, a camera is installed near the door mirror of a door on the side of the front passenger seat of the vehicle and takes an image of the conditions in the vicinities on the left rear side of the vehicle which becomes a dead angle from the driver. The image of the vicinities on the left rear side of the vehicle is displayed on the display unit. When the vehicle is to be turned to the left, for example, the user makes sure the safety from the displayed image of the vicinities on the left rear side of the vehicle.

In the conventional device for monitoring the vicinities of the vehicle, the camera takes an image of the conditions of the vicinities on the left rear side of the vehicle even when the door on the side of the front passenger seat is in a half-opened state, and the image of the vicinities on the left rear side of the vehicle is displayed on the display unit.

Here, the image taken in a state where the door on the side of the front passenger seat is half-opened is different from the image taken in a state where the door on the side of the front passenger seat has been closed. This problem could occur due to a change in the direction of the camera depending upon a change in the opening angle of the door on the side of the front passenger seat.

When, for example, the door on the side of the front passenger seat is in a half-opened state, a half-opened door alarm lamp in the compartment may turn on enabling the driver to notice that the door on the side of the front passenger seat is in the half-opened state. However, it may happen that the driver overlooks the half-opened door alarm lamp that is turned on.

In this case, the image of the vicinities on the left rear side of the vehicle displayed on the display unit is the one that is taken in a state where the door on the side of the front passenger seat is half-opened. However, the driver may incorrectly take it that the image of the vicinities on the left rear side of the vehicle is the one that is taken in a state where the door on the side of the front passenger seat is in the closed state.

### SUMMARY

In view of the above circumstances, it is an object to provide a device for monitoring the vicinities of a vehicle which prevents the driver from incorrectly recognizing the conditions in the vicinities of the vehicle.

In order to achieve the above object, a device for monitoring the vicinities of a vehicle according to one aspect includes a display unit; cameras installed on the doors of the vehicle to take images of the conditions in the vicinities of the vehicle; and display control processing means which instructs the cameras to take images of the conditions in the vicinities of the vehicle and displays, on the display unit, the images of the vicinities of the vehicle taken by the cameras. The device for monitoring the vicinities of the vehicle further includes door opening/closing detector means for detecting the opening/closing state of the doors of the vehicle; and halting means for halting the processing of the display control processing means when it is detected by the door opening/closing detector means that the doors of the vehicle are opening.

In the device for monitoring the vicinities of a vehicle according to one aspect as described above, it is probable that the driver may incorrectly recognize the conditions in the vicinities of the vehicle if the images of the vicinities of the vehicle are displayed on the display unit in a state where the doors of the vehicle are opened. Because of this reason, the processing of the display control processing means is interrupted when the doors of the vehicle are in the opened state, so that the images of the vicinities of the vehicle will not be displayed on the display unit when the doors of the vehicle are in the opened state. This prevents the driver from incorrectly recognizing the conditions in the vicinities of the vehicle.

According to a second aspect, it is desired that the halting means halts the display of images of the vicinities of the vehicle when it is detected that the doors of the vehicle are opening. Thus, images of the vicinities of the vehicle taken when the doors of the vehicle are opening are not displayed on the display unit.

According to a third aspect, the halting means interrupts the instruction to the cameras so that images of the conditions in the vicinities of the vehicle are not taken when it is detected that the doors of the vehicle are opening. Thus, the conditions in the vicinities of the vehicle are not imaged by the cameras when the doors of the vehicle are opened. Thus, images of the vicinities of the vehicle are not displayed when the doors of the vehicle are opened.

Further, a device for monitoring the vicinities of a vehicle according to a fourth aspect includes: a display unit; cameras installed on the doors of the vehicle to take images of the conditions in the vicinities of the vehicle; and display control processing means which instructs the cameras to take images of the conditions in the vicinities of the vehicle, forms bird's eye images based on the images of the vicinities of the vehicle taken by the cameras, and displays, on the display unit, the thus formed bird's eye images. The device for monitoring the vicinities of the vehicle further includes door opening/closing detector means for detecting the opening/closing state of the doors of the vehicle; and halting means for halting the processing of the display control processing means when it is detected by the door opening/closing detector means that the doors of the vehicle are opening.

When it is detected that the doors of the vehicle are opened, the processing of the display control processing means is interrupted even when the bird's eye images are formed based on the images of the vicinities of the vehicle taken by the cameras so not to display the thus formed bird's eye images on the display unit. This prevents the driver from incorrectly recognizing the conditions in the vicinities of the vehicle.

According to a fifth aspect, it is desired that the halting means halts the display of bird's eye images when it is detected that the doors of the vehicle are opening. Thus, the bird's eye images that are formed are not displayed on the display unit despite of taking images of the vicinities of the vehicle when the doors of the vehicle are opened.

According to a sixth aspect, the halting means may halt the formation of bird's eye images when it is detected that the doors of the vehicle are opening. Thus, the bird's eye images are no longer formed based on the images of the vicinities of the vehicle taken when the doors of the vehicle are opened. Therefore, no bird's eye image is displayed on the display unit when the doors of the vehicle are in the opened state.

According to a seventh aspect, the halting means interrupts the instruction to the cameras so that images of the conditions in the vicinities of the vehicle are not taken when it is detected that the doors of the vehicle are opening. Thus, the conditions of the vicinities of the vehicle are not imaged by the cameras when the doors of the vehicle are opening. No bird's eye image is formed since there is no image of the vicinities of the vehicle which serves as a basis for forming the bird's dye image. As a result, no bird's eye image is displayed on the display unit.

According to an eighth aspect, it is desired to provide notifying means for notifying a message stating that the doors of the vehicle are opening when it is detected that the doors of the vehicle are opening. Then, the driver can recognize the halt of the processing of the display control processing means due to the opened doors of the vehicle.

According to a ninth aspect, the notifying means can notify by voice the message stating that the doors of the vehicle are opening. Therefore, the driver can grasp that the doors of the vehicle are opening relying upon his hearing sense.

According to a tenth aspect, the notifying means can display, on the display unit, the message stating that the doors of the vehicle are opening. Therefore, the driver can grasp that the doors of the vehicle are opening relying upon his visual sense.

According to an eleventh aspect, the user may select the execution of notice of the message stating that the doors of the vehicle are opening of the notifying means. Thus, the user is allowed to select the execution of the notifying means.

### BRIEF DESCRIPTION OF THE DRAWINGS

FIG. 1 is a block diagram schematically illustrating the constitution of a device for monitoring the vicinities of a vehicle according to a first embodiment;

FIG. 2 is a diagram of images displayed on a display unit according to the first embodiment;

FIG. 3 is a flowchart illustrating a main routine of a display control processing of images of the vicinities the vehicle according to the first embodiment;

FIG. 4 is a diagram of images displayed on the display unit according to a second embodiment;

FIG. 5 is a diagram of images displaying, on a region, a message stating that the door on the side of the driver's seat is opening according to the second embodiment; and

FIG. 6 is a flowchart illustrating a main routine of a display control processing of bird's eye images of the vicinities the vehicle according to the second embodiment.

### DESCRIPTION OF THE PREFERRED EMBODIMENTS

### First Embodiment

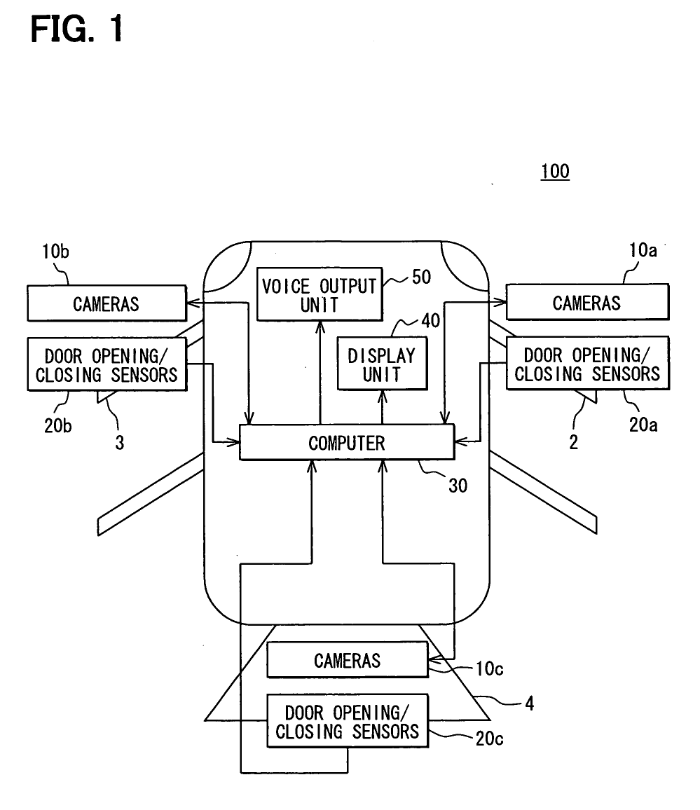

A preferred embodiment will now be described with reference to the drawings. FIG. 1 is a block diagram schematically illustrating the constitution of a device 100 for monitoring the vicinities of a vehicle according to the embodiment. The device 100 for monitoring the vicinities of the vehicle will be described below in detail.

The device 100 for monitoring the vicinities of the vehicle includes cameras 10a to 10c, door opening/closing sensors 20a to 20c, a computer 30, a display unit 40, and a voice output unit 50.

The computer 30 has known CPU, ROM, RAM, I/O and a bus line for connecting them incorporated therein. Programs to be executed by the computer 30 are written in the ROM, and the CPU and the like execute their predetermined operation processings according to the program.

The cameras 10a to 10c are, for example, CCD cameras which take images of the conditions in the vicinities of the vehicle which becomes dead angles from the driver. The cameras 10a to 10c start and end taking images according to an image start signal and an image end signal from the computer 30. Further, the cameras 10a to 10c send images of the vicinities of the vehicle that are taken to the computer 30.

The camera 10a is provided, for example, near the door mirror of a door 2 on the side of the driver's seat and takes an image of the conditions of the vicinities on the right rear side of the vehicle. The camera 10b is provided, for example, near the door mirror of a door 3 on the side of the front passenger seat and takes an image of the conditions of the vicinities on the left rear side of the vehicle. Further, the camera 10c is provided, for example, on a back door 4 and takes an image of the conditions in the vicinities at the back of the vehicle.

The door opening/closing sensors 20a to 20c detect the opening/closing of doors of the vehicle by detecting the state of latches provided for the doors of the vehicle. When the latch is released in a state where the latch had been fixed, the door is regarded to be opened. Conversely, when the latch is fixed in a state where the latch had been released, the door is regarded to be closed.

The door opening/closing sensor 20a detects the opening/closing of the door 2 on the side of the driver's seat, and the door opening/closing sensor 20b detects the opening/closing of the door 3 on the side of the front passenger seat. Further, the door opening/closing sensor 20c detects the opening/closing of the back door 4.

The display unit 40 is constituted by, for example, a liquid crystal display, and displays an image output from the computer 30.

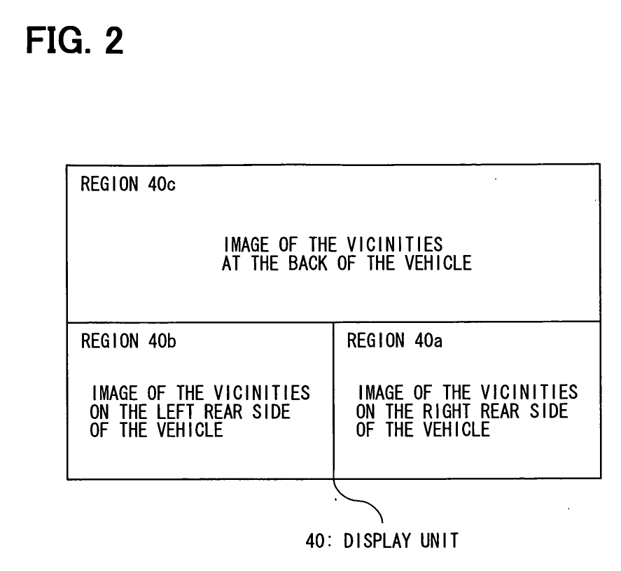

The display unit 40 in this embodiment is divided into three regions including a region 40a, a region 40b and a region 40c as shown in FIG. 2. The region 40a displays the image of the vicinities on the right rear side of the vehicle taken by the camera 10a. The region 40b displays the image of the vicinities on the left rear side of the vehicle taken by the camera 10b. The region 40c displays the image of the vicinities at the back of the vehicle taken by the camera 10c.

The voice output unit 50 comprises a speaker or the like. When it is detected that the door 2 on the side of the driver's seat is opened, the door 3 on the side of the front passenger seat is opened, or the back door 4 is opened, the voice output unit 50 produces a voice guide message stating that the door 2 on the side of the driver's seat is opened, the door 3 on the side of the front passenger seat is opened or the back door 4 is opened.

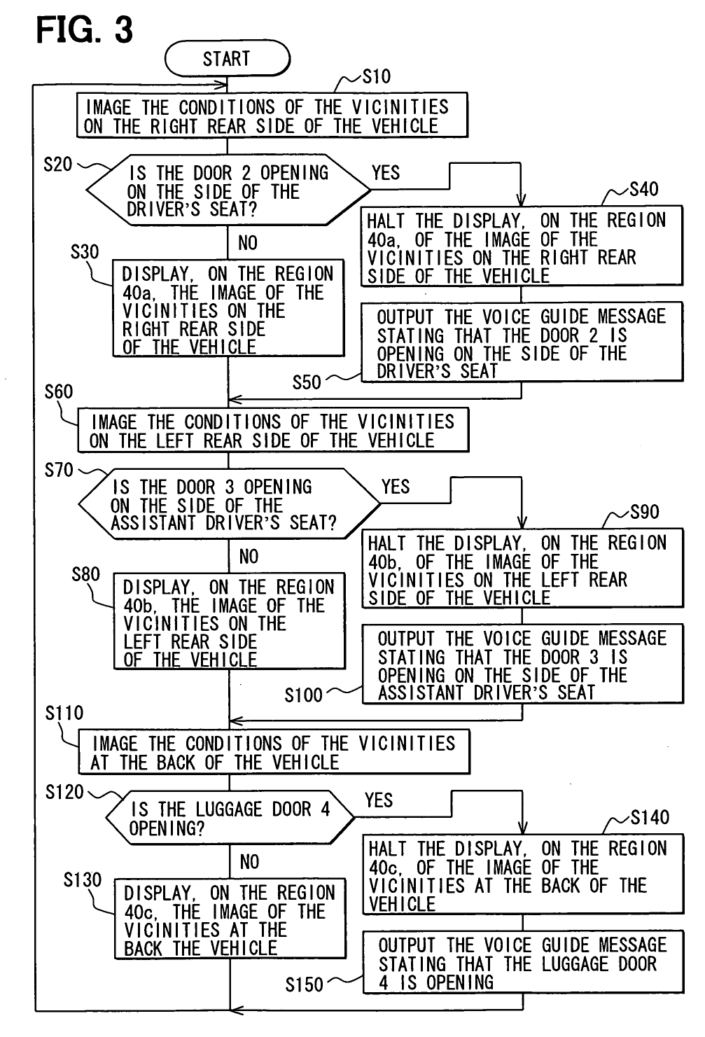

Next, the processing for controlling the display of the image of the vicinities of the vehicle according to the embodiment will be described in detail with reference to a flowchart of FIG. 3. Here, FIG. 3 is a flowchart illustrating the main routine of the processing for controlling the display of the image of the vicinities of the vehicle.

At step S10 in FIG. 3, first, the camera 10a takes an image of the conditions of the vicinities on the right rear side of the vehicle, and the image of the vicinities on the right rear side of the vehicle that is taken is output to the computer 30.

At step S20, it is judged whether the door 2 is opening on the side of the driver's seat. That is, it is judged whether the door opening/closing sensor 20a has output a signal that represents the opening of door 2 on the side of the driver's seat. When it is judged that there has been output no signal that represents the opening of the door 2 on the side of the driver's seat, the routine proceeds to step S30. At step S30, the computer 30 outputs, to the display unit 40, an image of the vicinities on the right rear side of the vehicle, and the thus output image of the vicinities on the right rear side of the vehicle is displayed on the region 40a.

When it is judged at step S20 that there is output a signal representing the opening of the door 2 on the side of the driver's seat, the routine proceeds to step S40. At step S40, the image of the vicinities on the right rear side of the vehicle is interrupted from being output to the display unit 40 from the computer 30; i.e., the image of the vicinities on the right rear side of the vehicle is no longer displayed on the region 40a. Thus, when the door 2 is opened on the side of the driver's seat, the image of the vicinities on the right rear side of the vehicle that is taken is no longer displayed on the region 40a.

At step S50, there is produced a voice guide message stating that the door 2 is opening on the side of the driver's seat. Concretely speaking, the voice guide message stating that “the door is opening on the side of the driver's seat” is produced by voice via, for example, the voice output unit 50. Therefore, the driver recognizes the interruption of processing for displaying the image of the vicinities on the right rear side of the vehicle on the region 40a since the door 2 is opening on the side of the driver's seat. The driver may further grasp that the door 2 is opening on the side of the drivers seat based on his hearing sense.

At step S60, the camera 10b takes an image of the conditions of the vicinities on the left rear side of the vehicle, and the image of the vicinities on the left rear side of the vehicle that is taken is output to the computer 30.

At step S70, it is judged whether the door 3 is opening on the side of the front passenger seat. That is, it is judged whether the door opening/closing sensor 20b has output a signal that represents the opening of door 3 on the side of the front passenger seat. When it is judged that there has been output no signal that represents the opening of the door 3 on the side of the front passenger seat, the routine proceeds to step S80.

At step S80, the computer 30 outputs, to the display unit 40, an image of the vicinities on the left rear side of the vehicle, and the thus output image of the vicinities on the left rear side of the vehicle is displayed on the region 40b.

When it is judged at step S70 that there is output a signal representing the opening of the door 3 on the side of the front passenger seat, the routine proceeds to step S90. At step S90, the image of the vicinities on the left rear side of the vehicle is interrupted from being output to the display unit 40 from the computer 30; i.e., the image of the vicinities on the left rear side of the vehicle is no longer displayed on the region 40b. Thus, when the door 3 is opened on the side of the front passenger seat, the image of the vicinities on the left rear side of the vehicle that is taken is no longer displayed on the region 40b.

At step S100, there is produced a voice guide message stating that the door 3 is opening on the side of the front passenger seat. Concretely speaking, the voice guide message stating that “the door is opening on the side of the front passenger seat” is produced by voice via, for example, the voice output unit 50. Therefore, the driver recognizes the interruption of processing for displaying the image of the vicinities on the left rear side of the vehicle on the region 40b since the door 3 is opening on the side of the front passenger seat. The driver may further grasp that the door 3 is opening on the side of the front passenger seat based on his hearing sense.

At step S110, the camera 10c takes an image of the conditions of the vicinities at the back of the vehicle, and the image of the vicinities at the back of the vehicle that is taken is output to the computer 30.

At step S120, it is judged whether the back door 4 is opening. That is, it is judged whether the door opening/closing sensor 20c has output a signal that represents the opening of back door 4. When it is judged that there has been output no signal that represents the opening of the back door 4, the routine proceeds to step S130.

At step S130, the computer 30 outputs, to the display unit 40, an image of the vicinities at the back of the vehicle, and the thus output image of the vicinities at the back of the vehicle is displayed on the region 40c.

When it is judged at step S120 that there is output a signal representing the opening of the door 4, the routine proceeds to step S140.

At step S140, the image of the vicinities at the back of the vehicle is interrupted from being output to the display unit 40 from the computer 30; i.e., the image of the vicinities at the back of the vehicle is no longer displayed on the region 40c.

Thus, when the back door 4 is opened, the image of the vicinities at the back of the vehicle that is taken is no longer displayed on the region 40c.

At step S150, there is produced a voice guide message stating that the back door 4 is opening. Concretely speaking, the voice guide message stating that “the back door is opening” is produced by voice via, for example, the voice output unit 50. Therefore, the driver recognizes the interruption of processing for displaying the image of the vicinities at the back of the vehicle on the region 40c since the back door 4 is opening. The driver may further grasp that the back door 4 is opening based on his hearing sense.

According to this embodiment as described above, it is probable that the driver may incorrectly recognize the conditions in the vicinities on the right rear side of the vehicle if the image of the vicinities on the right rear side of the vehicle is displayed on the region 40a in a state where the door 2 is opening on the side of the driver's seat. Because of this reason, a series of processings is interrupted from displaying the image of the vicinities on the right rear side of the vehicle on the region 40a when the door 2 is opening on the side of the driver's seat, so that the image of the vicinities on the right rear side of the vehicle will not be displayed on the display region 40a when the door 2 is opening on the side of the driver's seat. Similarly, when the door 3 is opening on the side of the front passenger seat or when the back door 4 is opening, a series of processings is interrupted from displaying the image of the vicinities on the left rear side of the vehicle on the region 40b or from displaying the image of the vicinities at the back of the vehicle on the region 40c. This prevents the driver from incorrectly recognizing the conditions in the vicinities of the vehicle.

### Modified Embodiment

The above embodiment applies to an example in which it is so judged that the door 2 is opening on the side of the drivers seat, the image of the vicinities on the right rear side of the vehicle taken by the camera 10a is interrupted from being displayed on the region 40a. When it is judged that the door 2 is opening on the side of the driver's seat, however, the camera 10a may be halted from taking the image of the vicinities on the right rear side of the vehicle.

Described below is a procedure for interrupting the camera 10a from taking an image of the conditions in the vicinities on the right rear side of the vehicle.

First, the computer 30 judges whether the door 2 is opening on the side of the driver's seat. When it is judged that the door 2 is opening on the side of the driver's seat, the computer 30 sends an imaging end signal to the camera 10a. In response to the imaging end signal that is sent, the camera 10a ends taking the image of the vicinities on the right rear side of the vehicle. When the door 2 is opening on the side of the drivers seat as described above, the camera 10a does not take the image of the conditions in the vicinities on the right rear side of the vehicle. Therefore, when the door 2 on the side of the driver's seat is opening, the image of the vicinities on the right rear side of the vehicle is not displayed on the region 40a.

Similarly, when it is judged that the door 3 is opening on the side of the front passenger seat or the back door 4 is opening, the camera 10b or the camera 10c may be interrupted from taking the image of the conditions in the vicinities on the left rear side of the vehicle or may be interrupted from taking the image of the conditions in the vicinities at the back of the vehicle.

### Second Embodiment

Next, a second embodiment will be described. The device for monitoring the vicinities of a vehicle according to this embodiment has nearly the same constitution as that of the device 100 for monitoring the vicinities of a vehicle of the above embodiment. Therefore, the above constitution is not described here again.

According to the second embodiment, the computer 30 converts the images of the vicinities of the vehicle output from the cameras 10a to 10c into data of a plane coordinate system with the ground plane as a reference to form a bird's eye image. The method of forming the bird's eye image based on the images of the vicinities of the vehicle has been described in detail in, for example, JP-A-10-211849, the contents of which are incorporated herein by reference, but is not described here any further. According to the second embodiment, further, the computer 30 sends the bird's eye image that is formed to the display unit 40.

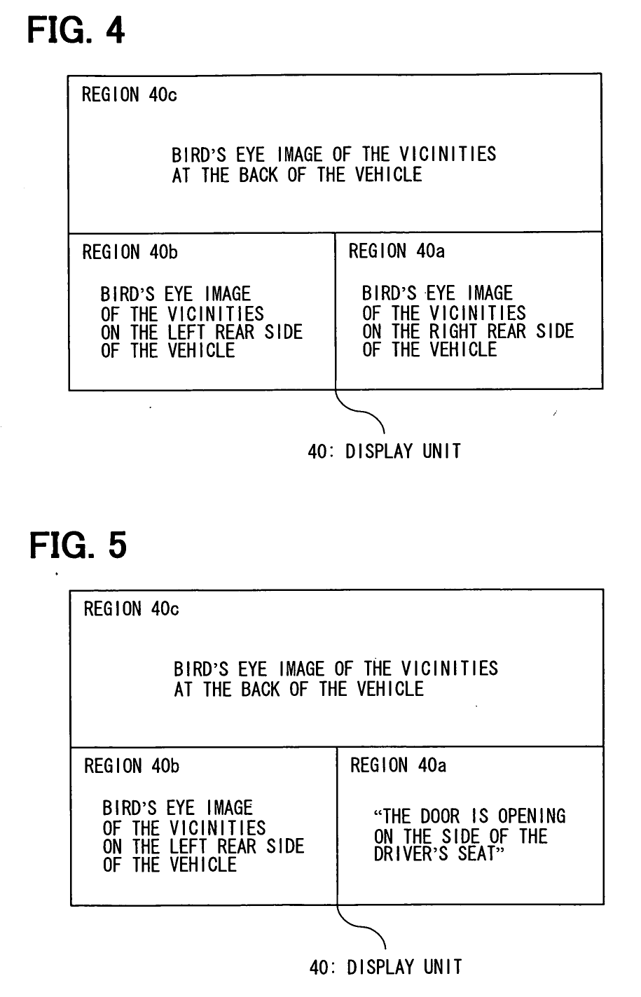

As shown in FIG. 4, the display unit 40 according to the second embodiment displays a bird's eye image of the vicinities on the right rear side of the vehicle on a region 40a, and displays a bird's eye image of the vicinities on the left rear side of the vehicle on a region 40b. Further, a bird's eye image of the vicinities at the back of the vehicle is displayed on a region 40c.

Thus, unlike the first embodiment, the device for monitoring the vicinities of the vehicle according to the second embodiment displays the bird's eye images of the vicinities of the vehicle on the display unit 40.

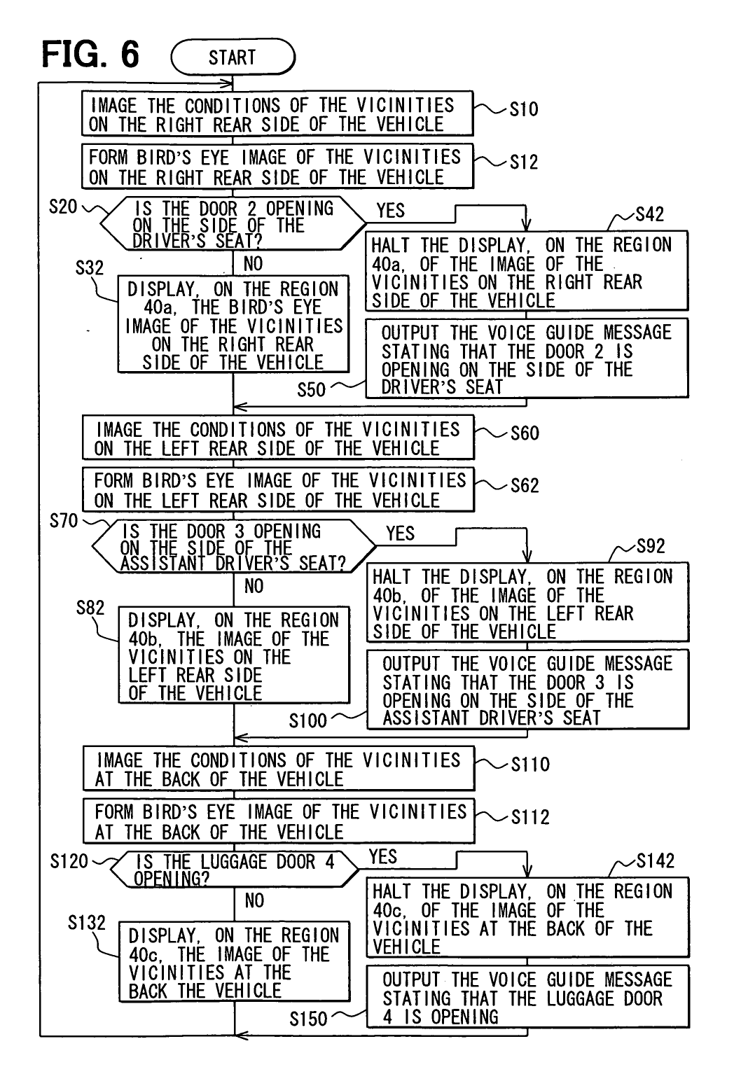

Next, described below with reference to a flowchart of FIG. 6 is a processing for controlling the display of a bird's eye image of the vicinities of the vehicle according to the embodiment. Further, the second embodiment executes the processing which is in common with that of the first embodiment. Therefore, the common processing is not described here again.

First, described below is the processing for controlling the display of the bird's eye image of the vicinities on the right rear side of the vehicle at steps S10 to S50 in FIG. 6. At step S10, the camera 10a takes an image of the conditions of the vicinities on the right rear side of the vehicle, and the image of the vicinities on the right rear side of the vehicle that is taken is output to the computer 30. At step S12, a bird's eye image of the vicinities on the right rear side of the vehicle is formed based on the image of the vicinities on the right rear side of the vehicle.

At step S20, it is judged whether the door 2 is opening on the side of the drivers seat. When it is judged that the door 2 is not opening on the side of the drivers seat, the routine proceeds to step S32. At step S32, the computer 30 outputs, to the display unit 40, the bird's eye image of the vicinities on the right rear side of the vehicle, and the thus output bird's eye image of the vicinities on the right rear side of the vehicle is displayed on the region 40a.

When it is judged at step S20 that the door 2 is opening on the side of the driver's seat, the routine proceeds to step S42. At step S42, the bird's eye image of the vicinities on the right rear side of the vehicle is interrupted from being output to the display unit 40 from the computer 30; i.e., the bird's eye image of the vicinities on the right rear side of the vehicle is no longer displayed on the region 40a. Thus, when the door 2 is opening on the side of the driver's seat, the bird's eye image of the vicinities on the right rear side of the vehicle that is formed based on the image of the vicinities on the right rear side of the vehicle, is no longer displayed on the region 40a. At step S50, there is produced a voice guide message stating that the door 2 is opening on the side of the driver's seat.

Similarly, the processing for controlling the display of the bird's eye image of the vicinities on the left rear side of the vehicle corresponds to step S60 to step S100, and the processing for controlling the display of the bird's eye image of the vicinities at the back of the vehicle corresponds to step S110 to step S150. Described below is a processing different from those of step S60 to step S150 of the first embodiment.

At steps S62 and S112, a bird's eye image of the vicinities on the left rear side of the vehicle and a bird's eye image of the vicinities at the back of the vehicle are formed based on the image of the vicinities on the left rear side of the vehicle and based on the image of the vicinities at the back of the vehicle.

When it is judged at steps S70 and S120 that the door 3 is not opening on the side of the front passenger seat or the back door 4 is not opening, the routine proceeds to steps S82 and S132. At steps S82 and S132, the computer 30 outputs the bird's eye image of the vicinities on the left rear side of the vehicle or the bird's eye view of the vicinities at the back of the vehicle to the display unit 40, so that the bird's eye image of the vicinities on the left rear side of the vehicle and the bird's eye image of the vicinities at the back of the vehicle are displayed on the regions 40b and 40c.

On the other hand, when it is judged at steps S70 and S120 that the door 3 is opening on the side of the front passenger seat or the back door 4 is opening, the routine proceeds to steps S92 and S142. At steps S92 and S142, the bird' eye image of the vicinities on the left rear side of the vehicle and the bird's eye image of the vicinities at the back of the vehicle are not output to the display unit 40 from the computer 30. Therefore, the bird's eye image of the vicinities on the left rear side of the vehicle and the bird's eye image of the vicinities at the back of the vehicle are not displayed on the regions 40b and 40c.

According to this embodiment as described above, even when the bird's eye image of the vicinities on the right rear side of the vehicle is formed based on the image of the vicinities on the right rear side of the vehicle taken by the camera 10a and even when the thus formed bird's eye image of the vicinities on the right rear side of the vehicle is to be displayed on the region 40a, a series of the processings is interrupted provided the door 2 is opening on the side of the driver's seat, so that the bird's eye image of the vicinities on the right rear side of the vehicle will not be displayed on the display region 40a. Similarly, when the door 3 is opening on the side of the front passenger seat or when the back door 4 is opening, a series of the processings is interrupted, so that the bird's eye image of the vicinities on the left rear side of the vehicle will not be displayed on the region 40b and that the bird's eye image of the vicinities at the back of the vehicle will not be displayed on the region 40c. This prevents the driver from incorrectly recognizing the conditions in the vicinities of the vehicle.

### Modified Embodiment

The above embodiment applies to an example in which it is judged that the door 2 is opened on the side of the driver's seat, the bird's eye image of the vicinities on the right rear side of the vehicle is interrupted from being displayed on the region 40a. When it is judged that the door 2 is opened on the side of the driver's seat, however, the camera 10a may be halted from taking the image of the vicinities on the right rear side of the vehicle.

Described below is a procedure for interrupting the camera 10a from taking an image of the conditions in the vicinities on the right rear side of the vehicle.

First, the computer 30 judges whether the door 2 is opening on the side of the driver's seat. When it is judged that the door 2 is opening on the side of the driver's seat, the computer 30 sends an imaging end signal to the camera 10a. In response to the imaging end signal that is sent, the camera 10a ends taking the image of the vicinities on the right rear side of the vehicle. When the door 2 is opening on the side of the driver's seat as described above, the camera 10a does not take the image of the conditions in the vicinities on the right rear side of the vehicle. The bird's eye image is not formed since there is no image of the vicinities on the right rear side of the vehicle that serves as a basis for the bird's eye image of the vicinities on the right rear side of the vehicle As a result, the bird's eye image of the vicinities on the right rear side of the vehicle is not displayed on the region 40a.

Similarly, when it is judged that the door 3 is opening on the side of the front passenger seat or the back door 4 is opening, the camera 10b or the camera 10c may be interrupted from taking the image of the conditions in the vicinities on the left rear side of the vehicle or may be interrupted from taking the image of the conditions in the vicinities at the back of the vehicle.

Further, when, for example, it is judged that the door 2 is opening on the side of the driver's seat, the bird's eye image of the vicinities on the right rear side of the vehicle may not be formed based upon the image of the vicinities on the right rear side of the vehicle taken by the camera 10a.

Described below is a procedure for not forming the bird's eye image of the vicinities on the right rear side of the vehicle based on the image of the vicinities on the right rear side of the vehicle by using the computer 30.

First, the camera 10a takes an image of the vicinities on the right rear side of the vehicle, and the image of the vicinities on the right rear side of the vehicle is output to the computer 30. Next, the computer 30 judges whether the door 2 is opening on the side of the driver's seat. When it is judged that the door 2 is opening on the side of the drivers seat, the computer 30 no longer forms the bird's eye image of the vicinities on the right rear side of the vehicle based on the image of the vicinities on the right rear side of the vehicle. Thus, there is formed no bird's eye image of the vicinities on the right rear side of the vehicle based on the image of the vicinities on the right rear side of the vehicle that is taken while the door 2 is being opened on the side of the drivers seat. Therefore, when the door 2 is opening on the side of the driver's seat, the bird's eye image of the vicinities on the right rear side of the vehicle is not displayed on the region 40a.

Similarly, when it is judged that the door 3 is opened on the side of the front passenger seat or the back door 4 is opened, there may not be formed the bird's eye image of the vicinities on the left rear side of the vehicle or there may not be formed the bird's eye image of the vicinities at the back of the vehicle based on the image of the vicinities on the left rear side of the vehicle or based on the image of the vicinities at the back of the vehicle taken by the camera 10b or the camera 10c.

In the above embodiments, further, when it is judged that the door 2 is opened on the side of the drivers seat, the voice guide message is output stating that the door 2 is opened on the side of the drivers seat. When it is judged that the door 2 is opened on the side of the driver's seat, a message may be displayed on the region 40a stating that the door 2 is opened on the side of the driver's seat. Concretely as shown in FIG. 5, the message “The door is opened on the side of the driver's seat” is displayed on the region 40a. This enables the driver to grasp that the door 2 is opened on the side of the driver's seat based on his visual sense.

Similarly, when it is judged that the door 3 is opened on the side of the front passenger seat or the back door 4 is opening, a message may be displayed on the region 40b or on the region 40c stating that the door 3 is opened on the side of the front passenger seat or the back door 4 is opened.

Further, when, for example, it is judged that the door 2 is opened on the side of the driver's seat, the door 3 is opened on the side of the front passenger seat or the back door 4 is opened, the message may be output by voice stating that the door 2 is opened on the side of the driver's seat, the door 3 is opened on the side of the front passenger seat or the back door 4 is opening and the same message may further be displayed on the region 40a, on the region 40b or on the region 40c.

Further, when, for example it is judged that the door 2 is opened on the side of the driver's seat, the door 3 is opening on the side of the front passenger seat or the back door 4 is opened, the user may select the execution of notifying the message which states that the door 2 is opened on the side of the driver's seat, the door 3 is opened on the side of the front passenger seat or the back door 4 is opened. Thus, the user is allowed to select the execution of notifying the message which states that the door 2 is opened on the side of the drivers seat, the door 3 is opened on the side of the front passenger seat or the back door 4 is opened.

What is claimed is:

1. A device for monitoring the vicinity of a vehicle comprising:
a display unit;
cameras installed on the doors of the vehicle to take images of the conditions in the vicinities of the vehicle, and
display control processing means which instructs the cameras to take images of the conditions in the vicinities of the vehicle and displays, on the display unit, the images of the vicinities of the vehicle taken by the cameras;
the device for monitoring the vicinities of the vehicle further comprising:
door opening/closing detector means for detecting the opening/closing state of the doors of the vehicle; and
halting means for halting the processing of the display control processing means when it is detected by the door opening/closing detector means that the doors of the vehicle are opened.

2. A device for monitoring the vicinity of a vehicle according to claim 1, wherein the halting means halts the display of images of the vicinities of the vehicle when it is detected that the doors of the vehicle are opened.

3. A device for monitoring the vicinity of a vehicle according to claim 1, wherein the halting means interrupts the instruction to the cameras so that images of the conditions in the vicinities of the vehicle are not taken when it is detected that the doors of the vehicle are opened.

4. A device for monitoring the vicinity of a vehicle comprising:
a display unit;
cameras installed on the doors of the vehicle to take images of the conditions in the vicinities of the vehicle; and
display control processing means which instructs the cameras to take images of the conditions in the vicinities of the vehicle, forms bird's eye images based on the images of the vicinities of the vehicle taken by the cameras, and displays, on the display unit, the thus formed bird's eye images;
the device for monitoring the vicinities of the vehicle further comprising:
door opening/closing detector means for detecting the opening/closing state of the doors of the vehicle; and
halting means for halting the processing of the display control processing means when it is detected by the door opening/closing detector means that the doors of the vehicle are opened.

5. A device for monitoring the vicinity of a vehicle according to claim 4, wherein the halting means halts the display of bird's eye images when it is detected that the doors of the vehicle are opened.

6. A device for monitoring the vicinity of a vehicle according to claim 4, wherein the halting means may halt the formation of bird's eye images when it is detected that the doors of the vehicle are opened.

7. A device for monitoring the vicinity of a vehicle according to claim 4, wherein the halting means interrupts the instruction to the cameras so that images of the conditions in the vicinities of the vehicle are not taken when it is detected that the doors of the vehicle are opened.

8. A device for monitoring the vicinity of a vehicle according to claim 4, further comprising notifying means for notifying a message stating that the doors of the vehicle are opened when it is detected that the doors of the vehicle are opened.

9. A device for monitoring the vicinity of a vehicle according to claim 8, wherein the notifying means notifies by voice the message stating that the doors of the vehicle are opened.

10. A device for monitoring the vicinity of a vehicle according to claim 8, wherein the notifying means displays, on the display unit, the message stating that the doors of the vehicle are opened.

11. A device for monitoring the vicinity of a vehicle according to claim 8, wherein the user selects the execution of notice of the message stating that the doors of the vehicle are opened of the notifying means.

12. A device for monitoring the vicinity of a vehicle according to claim 1, further comprising notifying means for notifying a message stating that the doors of the vehicle are opened when it is detected that the doors of the vehicle are opened.

13. A device for monitoring the vicinity of a vehicle according to claim 12, wherein the notifying means notifies by voice the message stating that the doors of the vehicle are opened.

14. A device for monitoring the vicinity of a vehicle according to claim 12, wherein the notifying means displays, on the display unit, the message stating that the doors of the vehicle are opened.

15. A device for monitoring the vicinity of a vehicle according to claim 12, wherein the user selects the execution of notice of the message stating that the doors of the vehicle are opened of the notifying means.
